(19) United States
(12) Patent Application Publication
(10) Pub. No.: US 2008/0155248 A1
(43) Pub. Date: Jun. 26, 2008

(54) SMART CARDS INCLUDING BOOTING MODE ROTECTION AND METHODS OF OPERATING

(75) Inventor: Sung-Geun Park, Suwon-si (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/763,055

(22) Filed: Jun. 14, 2007

(30) Foreign Application Priority Data
Dec. 20, 2006 (KR) 2006-0130516

(51) Int. Cl. G06F 9/00

(52) U.S. Cl. 713/2

(57) ABSTRACT

A memory chip can include a non-volatile memory that includes a plurality of memory cells, where each of the memory cells is configured to store separate instances of the booting mode selection information in each of the respective plurality of memory cells. A booting mode control block is configured to read the separate instances of the booting mode selection information stored in each of the respective plurality of memory cell and to output a reset signal based on the separate instances of the booting mode selection information.

### CROSS-REFERENCE TO RELATED PATENT APPLICATIONS

This application claims priority under 35 U.S.C. §119 from Korean Patent Application No. 10-2006-0130516, filed on Dec. 20, 2006, the disclosure of which is hereby incorporated by reference herein in as if set forth in its entirety.

### FIELD OF THE INVENTION

The present invention relates to a field of electronics, and more particularly, to smart cards and methods of operating the same.

### BACKGROUND

In general, a smart card product using a Flash EEPROM uses two types of a booting mode, that is, a ROM booting mode and a flash booting mode, to boot the smart card.

In the ROM booting mode, a ROM booting code stored in a ROM is executed to control the initialization of hardware of the smart card or download of an application code in a non-volatile memory. In the flash booting mode, a flash booting code stored in the non-volatile memory is executed to initialize data for executing an application program.

FIG. 1 is a block diagram showing the booting mode operation of a general smart card. Referring to FIG. 1, a conventional smart card 100 includes a host interface 110, a booting mode control block 120, a register 130, a RAM 140, a ROM 150, a non-volatile memory 160, and a CPU 170. The host interface 110 interfaces with the smart card 100 for data received from a host or output to the host. When the smart card 100 is powered on, the booting mode control block 120 reads out and interprets booting mode selection information stored in the non-volatile memory 160 and outputs the booting mode selection signal sig_sel based on the interpreted booting mode selection information.

The booting mode selection information indicates information about a booting mode used to boot the smart card 100 among the ROM booting mode or the flash booting mode. The non-volatile memory 160 is divided into a plurality of memory cell areas and the booting mode selection information is stored in a memory cell area 161 that is assigned.

The CPU 170 receives the booting mode selection signal sig_sel output from the booting mode control block 120 and executes any one of the ROM booting code stored in the Rom 150 and the flash booting code stored in the non-volatile memory 160, in response to the received booting mode selection signal sig_sel, to boot the smart card 100. The booting mode of the smart card 100 can be selectively changed by changing the booting mode selection information stored in the memory cell area 161 that is assigned in the non-volatile memory 160 according to a command from the host.

### SUMMARY

Embodiments according to the invention can provide smart cards including booting mode protection and methods of operating the same. Pursuant to these embodiments a memory chip can include a non-volatile memory that includes a plurality of memory cells, where each of the memory cells is configured to store separate instances of the booting mode selection information in each of the respective plurality of memory cells. A booting mode control block is configured to read the separate instances of the booting mode selection information stored in each of the respective plurality of memory cell and to output a reset signal based on the separate instances of the booting mode selection information.

In some embodiments according to the invention, a memory chip can include a non-volatile memory that includes a plurality of memory cells, where each of the memory cells is configured to store separate instances of the booting mode selection information in each of the respective plurality of memory cells. A booting mode control block is configured to read the separate instances of the booting mode selection information stored in each of the respective plurality of memory cell and to output a booting mode selection signal based on the separate instances of the booting mode selection information.

In some embodiments according to the invention, a method of operating a smart card can include comparing separate instances of the booting mode selection information stored separately in a non-volatile memory to provide a comparison result, outputting a reset signal based on the comparison result, and resetting the smart card in response to the reset signal.

In some embodiments according to the invention, a method for driving a smart card includes comparing separate instances of the booting mode selection information stored separately in a non-volatile memory to provide a comparison result, outputting a control signal based on the comparison result, outputting a booting mode selection signal in response to the control signal, and executing ROM booting code or flash booting code in response to the booting code selection signal.

### BRIEF DESCRIPTION OF THE DRAWINGS

The above and other features and advantages of the present invention will become more apparent by describing in detail preferred embodiments thereof with reference to the attached drawings in which:

FIG. 1 is a block diagram showing the booting mode operation of a general smart card;

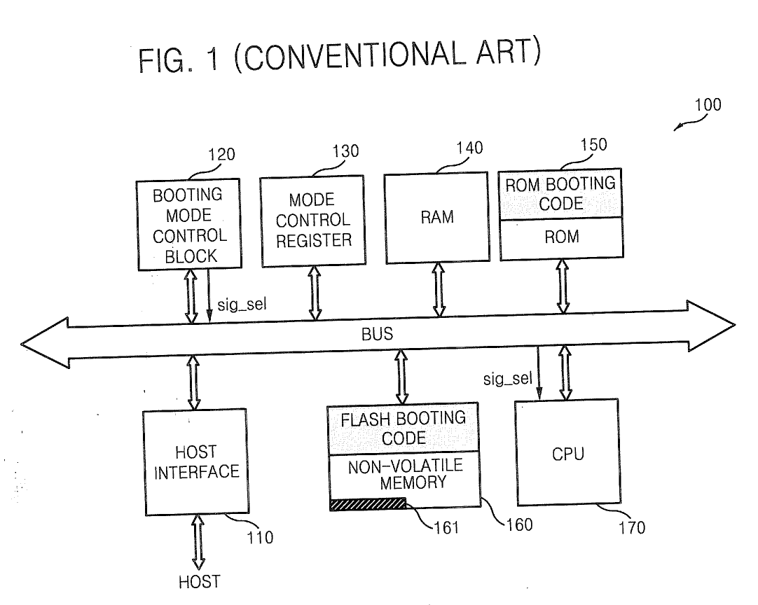

FIG. 2 is a block diagram showing the booting mode operation of a smart card according to an embodiment of the present invention;

FIG. 3 is a flowchart showing a method for driving the smart card of FIG. 2;

FIG. 4 is a block diagram of an electronic device having a system according to the present invention; and

FIGS. 5A through 5J illustrate electronic devices having the system according to the present invention.

### DESCRIPTION OF EMBODIMENTS ACCORDING TO THE INVENTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

As appreciated by the present inventors, since the smart card 100 stores the booting mode selection information only in a single memory cell area 161, if the booting mode selection information of the smart card 100 is unexpectedly changed (such as immediately after power up begins), the user may lose the capability to control the smart card 100. In particular, if the booting mode selection information is changed as a result of an external attack, such as through the use of the laser or voltage or current spike etc., important information, such as the application code, stored in the smart card 100 may be exposed and, therefore, vulnerable to piracy or tampering. Thus, as appreciated by the present inventors, it may be beneficial to detect when the booting mode selection information is changed before/during the boot of the smart card, even when the change is a result of an external attack.

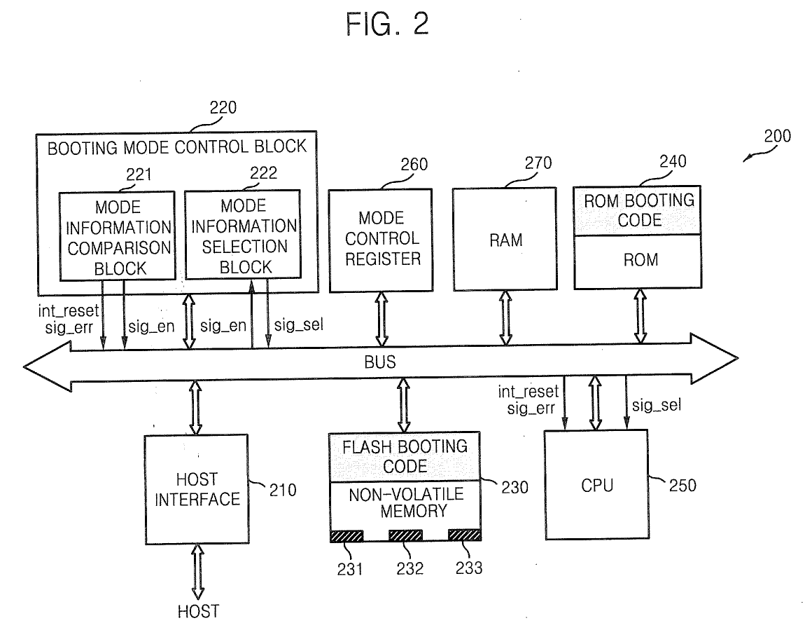

FIG. 2 is a block diagram showing the booting mode operation of a smart card in some embodiments according to the invention. Referring to FIG. 2, a smart card 200 includes a host interface 210, a booting mode control block 220, a non-volatile memory 230, a ROM 240, a CPU 250, a mode control register 260 and a RAM 270.

The host interface 210 interfaces with the smart card 200 for the data received from the host or output to the host. The booting mode control block 220 includes a comparison unit 221 and a selection unit 222. In some embodiments credit to the invention, when the smart card 200 is powered on, the comparison unit 221 reads booting mode selection information stored in each of a plurality of memory cells 231, 232, and 233 of the non-volatile memory 230 and compares the read information to determine whether the information stored there matches.

It will be understood that in some embodiments according to the invention, the term “match” includes situations where two or more pieces of data are exactly the same and also includes situations where the two or more pieces of data are different from one another, but indicate the same information. For example, in some embodiments according to the invention, a logical zero may be used to represent a type of boot mode in a first memory cell, whereas a logical one may be used to represent the same type of boot mode in a second memory cell.

When the booting mode selection information are matched according to the result of the comparison, the comparison unit 221 outputs a control signal sig-en to enable the selection unit 222. Otherwise, when the booting mode selection information do not match according to the result of the comparison, the comparison unit 221 outputs a reset signal int_reset or an error signal sig_err to reset the smart card 200 to the CPU 250. Although the comparison unit 221 is embodied by hardware in the smart card 200 according to the present embodiment, the present invention is not limited thereto and the comparison unit 221 can be embodied by software to produce the same effect.

The selection unit 222 receives the control signal sig_en and, in response to the received control signal sig_en, reads out and interprets the booting mode selection information stored in each of the memory cells 231, 232, and 233 of the non-volatile memory 230 and outputs a booting mode selection signal sig_sel based on the results of interpretation. The booting mode selection signal sig_sel is a signal to select and perform any one of the ROM booting code stored in the ROM 240 and the flash booting code stored in the non-volatile memory 230 based on the interpretation of the booting mode selection information.

That is, when the interpretation result of the booting mode selection information indicates first information, for example, ROM booting mode selection information, the selection unit 222 outputs a first control signal, for example, a logic “high”. When the interpretation result of the booting mode selection information indicates second information, for example, flash booting mode selection information, the selection unit 222 outputs a second control signal, for example, a logic “low”.

The non-volatile memory 230 includes the memory cells 231, 232, and 233 each storing the booting mode selection information. Also, the non-volatile memory 230 stores the flash booting code to execute the smart card 200 in the flash booting mode. The non-volatile memory 230 can be embodied by a flash EEPROM.

The booting mode selection information indicates information about which of the ROM booting mode or the flash booting mode is to be used to boot the smart card 200. The respective booting mode selection information stored in each of the memory cells 231, 232, and 233 are the same.

Each of the memory cells 231, 232, and 233 stores the booting mode selection information having the same contents. Thus, when at least one of the memory cells 231, 232, and 233 is changed by an external attack, for example, through the use of a laser or glitch (cost, for example, or a voltage or current spike), the comparison unit 221 outputs a reset signal int_reset or an error signal sig_err so that the smart card 200 can stop the booting mode and, instead, proceed with a reset mode or error mode.

For example, when the booting mode selection information stored in the first memory cell 231 is changed from the second information (flash booting mode selection information) to the first information (ROM booting mode selection information) by an external attack, the comparison unit 221 compares the booting mode selection information stored in each of the memory cells 231, 232, and 233 so as to recognize the presence of the external attack and output the reset signal int_reset or the error signal sig_err to stop the booting mode.

Each of the memory cells 231, 232, and 233 can be arranged to be separated from one another by a predetermined distance in the non-volatile memory 230. This is to help avoid a situation where more than one of the memory cells 231, 232, and 233 is damaged during the attack is those memory cells neighbor the memory cell under attack.

In some embodiments according to the invention, the smart card 200 has three memory cells for the convenience of explanation. However, the present invention is not limited thereto and the smart card 200 can use two or more memory cells. The ROM 240 stores a ROM booting code to boot the smart card 200 in the ROM booting mode. The ROM booting code is preferably stored in the ROM 240 but can be stored in a predetermined area of the non-volatile memory 230.

The CPU 250 receives the booting mode selection signal sig_sel and executes the ROM booting code in response to the first selection signal, for example, logic “high”, of the received booting mode selection signal sig_sel and the flash booting code in response to the second selection signal, for example, logic “low”, of the received booting mode selection signal sig_sel.

The register 260 temporarily loads the booting mode selection information for access by other devices, such as, the booting mode control block 220 and the CPU 250. The RAM 270 temporarily stores data transferred through a bus and stores the booting mode selection information.

As appreciated by the present inventors, if the booting mode selection information is temporarily loaded in a single register 260 and/or address within the RAM 270, the booting mode selection information therein may also be vulnerable to external attack. Thus, the smart card 200 preferably temporarily stores the booting mode selection information in a plurality of registers 260 and/or a plurality of addresses of the RAM 270.

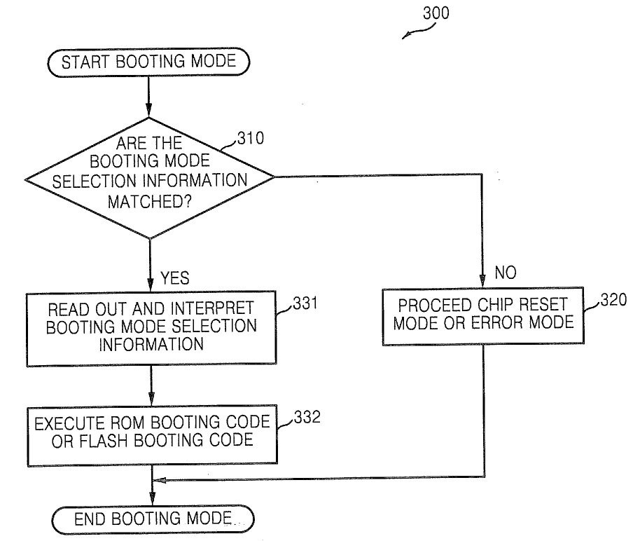

FIG. 3 is a flowchart showing a method for driving the smart card of FIG. 2. Referring to FIGS. 2 and 3, in the operation of the smart card, when the smart card 200 is powered on and begins a booting mode, that is, a booting code is executed, the smart card 200 reads the booting mode selection information stored in each of the memory cells 231, 232, and 233 of the non-volatile memory 230 and compares the respective read booting mode selection information (S310).

If the booting mode selection information does not match (S310), the smart card 200 determines that at least one of the memory cells has been modified by an external attack and outputs the reset signal int_reset or the error sig_err to stop the booting mode of the smart card 200 (S320). Thus, by detecting the modification of the booting mode selection information, malfunction of the booting mode may be avoided and the data or application program stored in the smart card 200 may be further protected from being leaked by the external attack.

If the booting mode selection information matches (S310), the smart card 200 determines that the booting mode selection information has not been tampered with and reads out and interprets the booting mode selection information stored in the non-volatile memory 230 (S331). The smart card 200 executes the ROM booting code or the flash booting code based on the interpretation of the booting mode selection information read from the non-volatile memory 230 (S332).

The booting mode selection information indicates which one of the ROM booting code or the flash booting code is to be used to boot the smart card 200. For example, when the booting mode selection information contains first information, for example, the ROM booting mode selection information, the smart card 200 performs the ROM booting mode by executing the ROM booting code stored in the ROM 240. On the other hand, when the booting mode selection information contains second information, for example, the flash booting mode selection information, the smart card 200 performs the flash booting mode by executing the flash booting code stored in the non-volatile memory 230.

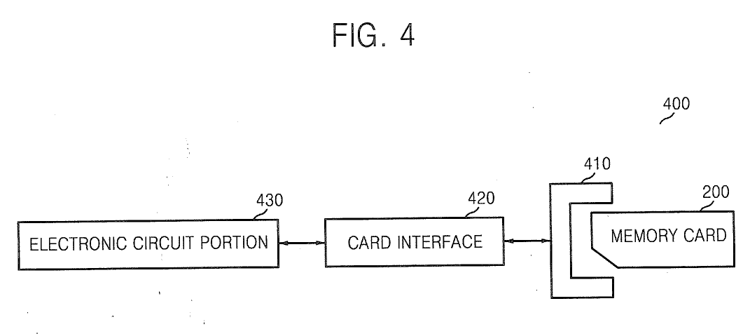

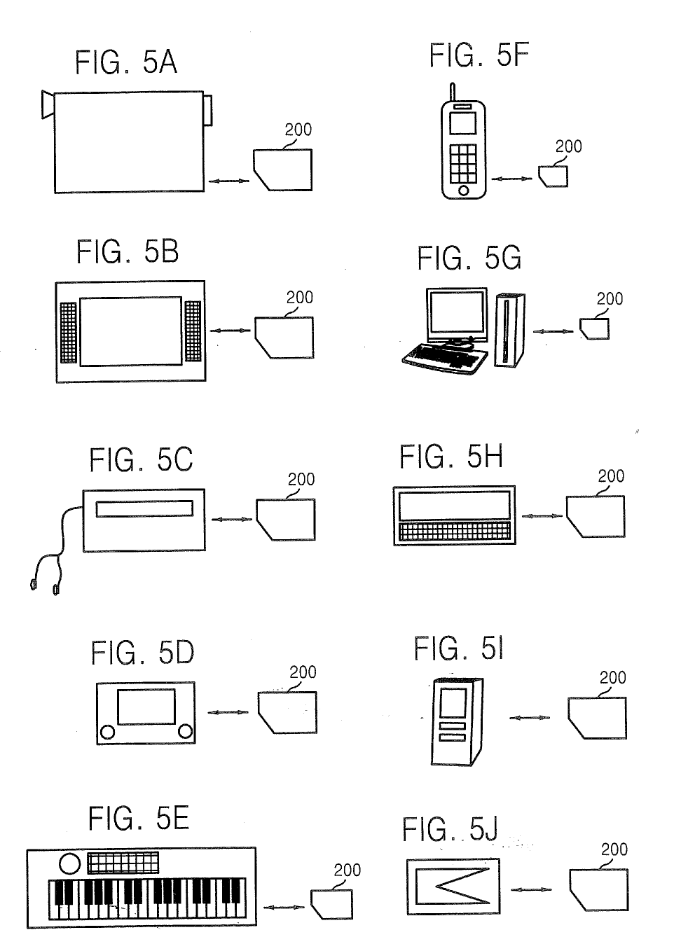

FIG. 4 is a functional block diagram of an electronic device in some embodiments according to the invention. FIGS. 5A through 5J illustrate electronic devices in some embodiments according to the invention. Referring to FIGS. 4 through 5J, a system according to an embodiment of the present invention can be embodied by a memory card. The memory card can be used for a video camera of FIG. 5A, a television set of FIG. 5B, a MP3 player of FIG. 5C, a game console of FIG. 5D, an electronic musical instrument of FIG. 5E, a portable terminal of FIG. 5F, a personal computer (PC) of FIG. 5G, a personal digital assistant (PDA) of FIG. 5H, a voice recorder of FIG. 5I, and a PC card of FIG. 5J.

Thus, when each of the video camera of FIG. 5A, the television set of FIG. 5B, the MP3 player of FIG. 5C, the game console of FIG. 5D, the electronic musical instrument of FIG. 5E, the portable terminal of FIG. 5F, the personal computer (PC) of FIG. 5G, the personal digital assistant (PDA) of FIG. 5H, the voice recorder of FIG. 5I, and the PC card of FIG. 5J includes an interface 420 of FIG. 4 and a slot 410 of FIG. 4 accessible to the interface 420, the system is connected to the slot 410 and exchanges predetermined data and commands through the interface 420 with a CPU or microprocessor provided at an electronic circuit portion 430 of FIG. 4 which are the video camera of FIG. 5A, the television set of FIG. 5B, the MP3 player of FIG. 5C, the game console of FIG. 5D, the electronic musical instrument of FIG. 5E, the portable terminal of FIG. 5F, the personal computer (PC) of FIG. 5G, the personal digital assistant (PDA) of FIG. 5H, the voice recorder of FIG. 5I, and the PC card of FIG. 5J. she

As described above, smart cards and methods in some embodiments according to the invention may improve the security by detecting an external attack where the booting mode selection information is modified by an external attack.

While this invention has been particularly shown and described with reference to preferred embodiments thereof, it will be understood by those skilled in the art that various changes in form and details may be made therein without departing from the spirit and scope of the invention as defined by the appended claims.

What is claimed:

1. A memory chip comprising:
a non-volatile memory including a plurality of memory cells, each of the memory cells configured to store separate instances of the booting mode selection information in each of the respective plurality of memory cells; and
a booting mode control block configured to read the separate instances of the booting mode selection information stored in each of the respective plurality of memory cell and configured to output a reset signal based on the separate instances of the booting mode selection information.

2. The memory chip of claim 1, wherein the booting mode selection information comprises information indicating a ROM booting mode or a flash booting mode.

3. The memory chip of claim 1, further comprising a ROM configured to store ROM booting code configured to operate the memory chip in a ROM booting mode.

4. The memory chip of claim 1, wherein the non-volatile memory is configured to store flash booting code to operate the memory chip in a flash booting mode.

5. The memory chip of claim 1, further comprising:
a plurality of registers, wherein each of the registers is configured to temporarily separately store the respective instances of the booting mode selection information read from the non-volatile memory.

6. The memory chip according to claim 1 included in a smart card, further comprising:
a CPU configured to reset the memory chip in response to the reset signal.

7. A memory chip comprising:
a non-volatile memory including a plurality of memory cells, each of the memory cells configured to store separate instances of the booting mode selection information in each of the respective plurality of memory cells; and
a booting mode control block configured to read the separate instances of the booting mode selection information stored in each of the respective plurality of memory cell and configured to output a booting mode selection signal based on the separate instances of the booting mode selection information.

8. The memory chip of claim 7, wherein the booting mode control block comprises:
a comparison unit configured to compare the separate instances of the booting mode selection information and output a control signal according to a result of the comparison; and
a selection unit configured to read and interpret the separate instances of the booting mode selection information in response to the control signal and to output a booting mode selection signal based on an interpretation result.

9. The memory chip of claim 7, further comprising:
a plurality of registers configured to temporarily separately store the separate instances of the booting mode selection information output from the non-volatile memory.

10. The memory chip of claim 7, further comprising:
a ROM configured to store ROM booting code to operate the memory chip in a ROM booting mode.

11. The memory chip of claim 7, wherein the non-volatile memory is configured to store a flash booting code to operate the memory chip in a flash booting mode.

12. The memory chip according to claim 7 included in a smart card, further comprising:
a CPU configured to execute the ROM booting code or the flash booting code in response to the booting mode selection signal.

13. A method of operating a smart card, the method comprising:
comparing separate instances of the booting mode selection information stored separately in a non-volatile memory to provide a comparison result;
outputting a reset signal based on the comparison result; and
resetting the smart card in response to the reset signal.

14. The method of claim 13, wherein the reset signal is activated when the respective separate instances of the booting mode selection information do not match.

15. A method for driving a smart card, the method comprising:
comparing separate instances of the booting mode selection information stored separately in a non-volatile memory to provide a comparison result;
outputting a control signal based on the comparison result;
outputting a booting mode selection signal in response to the control signal; and
executing ROM booting code or flash booting code in response to the booting code selection signal.

16. The method of claim 15, wherein the control signal is activated when the separate instances of the booting mode selection information match.
